(19) United States
(12) Patent Application Publication
(10) Pub. No.: US 2022/0258510 A1
(43) Pub. Date: Aug. 18, 2022

(54) Laser imaging printer and die cutter assembly

(71) Applicant: Primera Technology, Inc., Plymouth, MN (US)

(72) Inventors: Mark D. Strobel, Orono, MN (US); Darren W. Haas, Minnetonka, MN (US)

(21) Appl. No.: 17/544,626

(22) Filed: Dec. 7, 2021

Related U.S. Application Data
(60) Provisional application No. 63/149,925, filed on Feb. 16, 2021.

(51) Int. Cl. B41J 29/393; B23K 26/06

(52) U.S. Cl. CPC B41J 29/393; B23K 26/0648

(57) ABSTRACT

A system and method for printing and cutting labels comprising a laser printer assembly and a die cutting assembly positioned in a printer housing such that the media is printed and cut before advancing further through the system. A positioning block aligns the optical fibers of multiple laser diodes to direct laser beams to a print head. The print head is positioned such that the print head is tilted to adjust spacing of focal points of the laser beams on the media and thus set print resolution. The system eliminates the need for a filtration system when used with smokeless media. The print head includes a mirror and a focusing lens for steering the laser beams for laser printing and does not include a collimating lens.

### CROSS-REFERENCE TO RELATED APPLICATION

The present application claims priority to and the benefit of U.S. provisional application Ser. No. 63/149,925, filed on Feb. 16, 2021, the contents of which are hereby incorporated in their entirety.

### BACKGROUND

The present disclosure relates to a system for printing labels onto a continuous web and separating those labels from the web once printed. The system comprises a printing head and a cutting head such that the web passes below each head for printing and then cutting around the perimeters of a plurality of labels from the web.

Direct laser imaging produces high quality graphics on a media by using a focused beam or beams of light to produce text and images onto the media via laser ablation or phase change of the substrate. Laser imaging printers for labels also include printers which work with special media having chemical layers beneath the surface that are activated by the laser beams to create the printed images.

Systems incorporating a plotter cutter assembly into the printer system have been described in various patents including U.S. Pat. No. 6,616,360 directed to cutting assemblies to accommodate both end cutting and plotter cutting of a label media by a common drive; controllers for controlling the print head and cutting assemblies separately are described in U.S. Pat. No. 6,742,858; and depth control of plotter cutting has been described in U.S. Pat. No. 6,664,995.

Laser printing systems can be used to print on standard or smokeless media. Laser label printing systems are also configured to use the laser for printing as well as cutting a perimeter of the label printed. These systems require a filtration system, even if smokeless media is used for laser printing the labels as the laser is also used to cut the smokeless media and thus generating a plume of debris and smoke. The smoke that is generated by printing and cutting traditional laser markable media is toxic and it must be filtered for safety reasons, in addition to the smoke also accumulating on the laser optics if not properly filtered.

Laser label printers may use a media that is “pre-cut” before printing (pre-die cut labels), however, such laser markable material is typically meant to be used in “permanent” situations and is provided with a very aggressive adhesive that gums up typical large scale converting equipment and is time consuming and expensive to clean up.

In systems where the printing and cutting processes have been combined in the system such that the media is printed, and the printed images are then cut before the web advances further for subsequent printing and cutting, problems arise when moving the web of media through the system as different directional forces are applied to the media between printing and cutting. For example, knife cutters can drag the media to one side of the system or the other depending on the direction in which the knife is moving during cutting. These different forces can cause the media to skew off to the side of the original media path.

### SUMMARY

An aspect of the present disclosure relates to an assembly for printing and cutting print media having a housing and a print carriage within the housing and a laser printing assembly and a digital die cutting assembly, both being disposed on the carriage.

The laser printing assembly is configured to print content onto smokeless media and wherein the assembly does not require a filtration system.

The laser printing assembly comprises 2, 4, or 8 laser diodes.

The printing assembly further comprises a positioning block for aligning optical fibers through which laser beams are transmitted, a mirror and a focusing lens for directing the laser beams from the print carriage.

The laser printing assembly is tilted with respect to the print carriage to vary a spacing between pixels being formed on print media so as to control print resolution.

The laser printing assembly comprises a single mirror and a single focusing lens for directing laser beams to the print media.

The laser printing assembly does not require a collimating lens.

The print media is provided as a continuous web of print media fed through the housing for printing and cutting and wherein the assembly further comprises a sheet cutter for separating sheets or a small roll from a web of the print media.

Yet another aspect of the present disclosure relates to a printer for laser printing labels, the printer having a printing assembly comprising a focusing lens, a mirror and a laser beam transmission block containing multiple optic fibers disposed within the block for transmitting multiple laser beams therefrom and a print carriage. The printing assembly is positioned such that the multiple laser beams are tilted from a position orthogonal to the media to sufficiently adjust the formation of pixels to a selected dots per inch resolution.

The transmission block aligns laser beams from a plurality of laser diodes. The plurality of laser diodes can include two or more, four, or eight laser diodes or more.

The printing assembly is sufficiently tilted to form images on the media at a resolution of at least 300 DPI.

Another aspect of the present disclosure relates to a laser printer configured to print on smokeless media. The laser printer comprises a housing and a carriage within the housing. The printer further includes a laser block retaining multiple laser fibers positioned in a manner that directs laser beams from the laser fibers to the smokeless media without the use of a collimating lens while producing images having at least approximately 300 dpi resolution on the smokeless print media.

### BRIEF DESCRIPTION OF THE DRAWINGS

FIG. 1 is a front perspective view of the combination printing and cutting system.

FIG. 2 is a front perspective view of the combination printing and cutting system with the lid open.

FIG. 3 is a cross sectional side view of the combination printing and cutting system.

FIG. 4 is a cross sectional bottom view of one optical fiber positioning scheme.

FIG. 5 is a perspective view of the print carriage.

FIG. 6 is an embodiment of a print carriage showing a laser beam path from a source to media, the path through the print carriage.

FIG. 7 is a perspective view of a fiber optic positioning block.

FIG. 8 is a front view of the fiber optic positioning block.

FIG. 9 illustrates focal point spacing for laser printing.

FIG. 10 illustrates laser printing resolution in one printing embodiment.

FIG. 11 illustrates laser printing resolution in one printing embodiment.

FIG. 12 is a front perspective view of a printing system with die cutting assembly integrated therein and with a cover removed for exposure of internal parts.

FIGS. 13A, 13B and 13C illustrate parts for moving media through the system when printing and cutting.

### DETAILED DESCRIPTION

The system described herein comprises an assembly for printing a plurality of images on a print media and subsequently cutting a perimeter around each of the printed images to remove or separate each of the printed images from a web of media. The printing assembly described herein and laser arrangement may be incorporated into a laser printer, a direct thermal printer, thermal transfer printer or the like. The web of media is fed into the system and one or more first images are printed on the media with a print head configured for moving in reciprocal directions across a width of the web. A cutting head is also provided and configured for moving in reciprocal directions across the width of the web for then cutting or separating the one or more first images from the media. The web may then be further advanced into and through the system for the printing and cutting of one or more second images and so forth. The system further comprises a finishing cutter for cutting across the width of the media (across the web) or otherwise forming sheets or small rolls of media, where a sheet or small roll may support one or more images and where these sheets or small rolls are easier to remove from the system. The cut images can then be physically removed from the media and the scrap media discarded or recycled.

The print head and cutting head may be supported on the same gantry for linear movement of head or supported on adjacent gantries such that the print head and cutting head are moved over substantially a same processing window where the images are printed and cut in a same or substantially same location in the system, the locations below the travel path of the print and cutting heads also referred to as a processing window, which extends across the web. The media is then advanced and/or retracted through the processing window during printing and/or cutting for purposes of printing images and cutting images having regular or irregular perimeters.

Due to the movement of the web in the system corresponding to the print and or cutting head movement during printing or cutting, the media is generally guided through the system for purposes of maintaining alignment during printing and cutting. This allows the pre-programmed cutting path to match a perimeter of the printed image, ensuring that the image is properly cut out from the media.

The system described herein may further advantageously incorporate two pairs of pinch levers for alternately “pinching” or holding the media in the processing window during the printing and cutting processes, respectively. The pair of pinch levers engaged with the media then holds the media down and, in a printing, or cutting position for preventing side to side movement or drifting and maintaining the tension of the media so the media is flat during each respective operation. The pinch levers cooperate with a drive roller below the media for moving the media through the processing window.

The process described herein may be continuous such that a supply roll of media is fed through the system, one or more first images are printed and then substantially separated from the supply roll of media by cutting, and then printing resumes for printing one or more second images which are also then substantially separated from the supply roll via cutting. What is meant by the term “substantially separated” as used with respect to the cutting perimeters around the printed images is that the printed image is “cut out” and thus separated from the media but the substantially separated image is still carried by the web of media through the printer and the substantially separated image is not fully separated from the media until the printed and cut image is lifted or pushed out from the scrap media for collection and stacking etc. Full separation of the cut printed images may occur manually or automatically and may be carried out outside of the housing or by a mechanical lifting or pushing process incorporated into the device. This process may be repeated as the material advances through the assembly until a preselected number of images are printed and cut from the supply roll.

The system described herein is a combination laser printer and plotter cutter 10 illustrated generally in the figures. The combination laser printer and plotter cutter 10 is a system for printing images on a substrate or moving web and separating or cutting those images from the substrate or moving web. The system 10 includes a printing assembly 20 and a cutting assembly 30. The system may further include a sheet or finishing cutter 40 for cross-cutting the media 18 to provide sheets or small rolls cut from the web, whether or not these sheets contain printed and cut images.

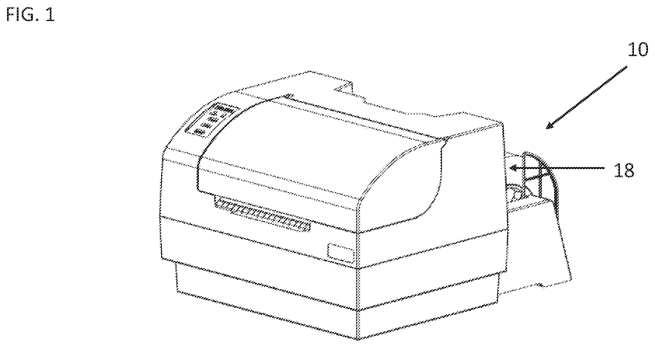

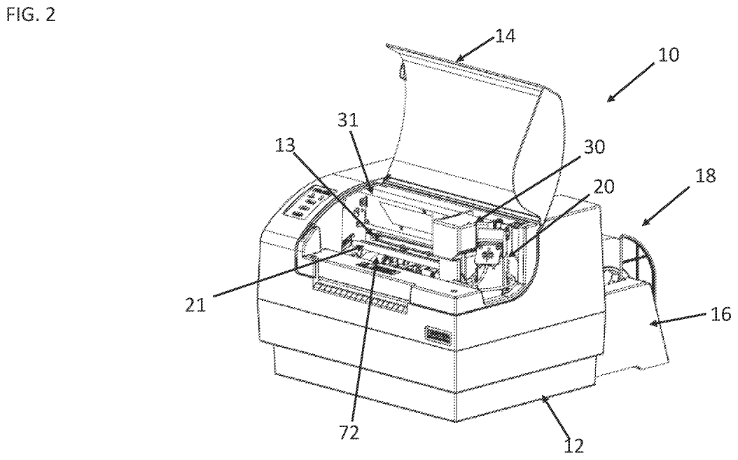

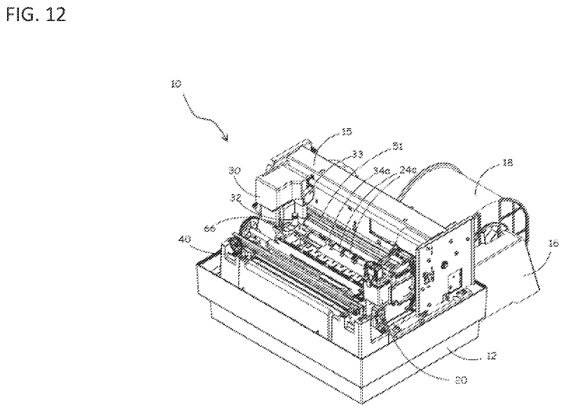

As illustrated in the figures, the combination printer and cutter 10 is provided in a housing 12 having a lid 14. In the embodiment illustrated in FIGS. 1-2 and 12, a supply roll of media 18 is supported on a roll web guide 16 on the housing. The housing 12 otherwise supports the operational components of the printer and cutter 10 therein. A motor 13 is provided for powering the operation of the printing assembly 20 and the cutting assembly 30. However, the printing assembly 20 and the cutting assembly 30 are independently operable for independent movement. For example, in the embodiment illustrated, the printing assembly 20 is a carriage 22 movable on a lower guide shaft 21 and on an upper guide shaft 31. The cutting assembly 30 is also movable on the lower guide shaft 21 and upper guide shaft 31. The guide shafts may be positioned near or proximate one another with one shaft above another shaft such that the print head and cutting head move across the width of the media in substantially the same area of the system.

The roll web guide 16 for the supply roll of media 18 is configured to allow the roll of media 18 to rotate for feeding the media 18 into the housing 12 for printing and/or cutting of print images. In one embodiment the system 10 is a label printer and cutter. A series of rollers including a drive roller 50 aids in controlling the movement of the media 18 into and through the housing 12 for printing and cutting. That is, the media 18 is fed through the housing 12 in a web direction and through a processing window such that the media 18 passes below the printing assembly 20 and cutting assembly 30.

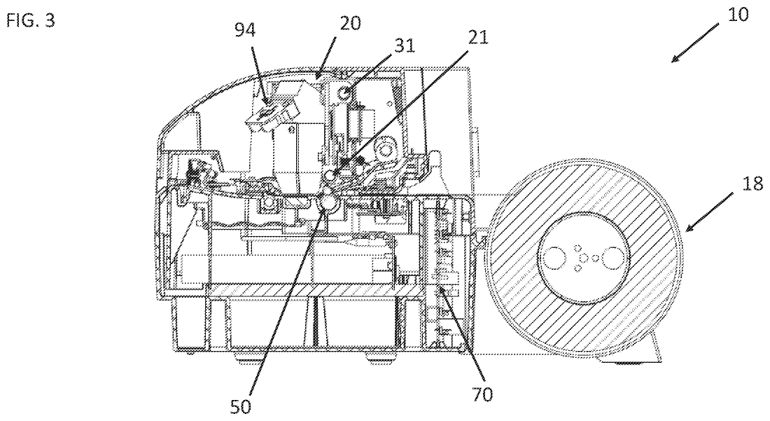

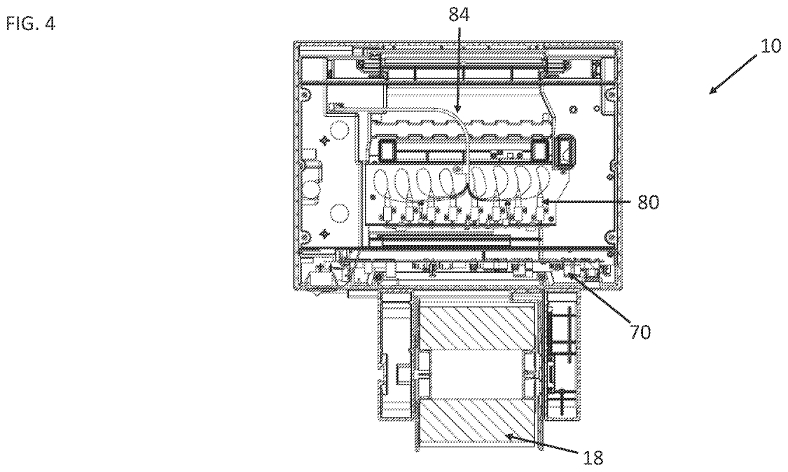

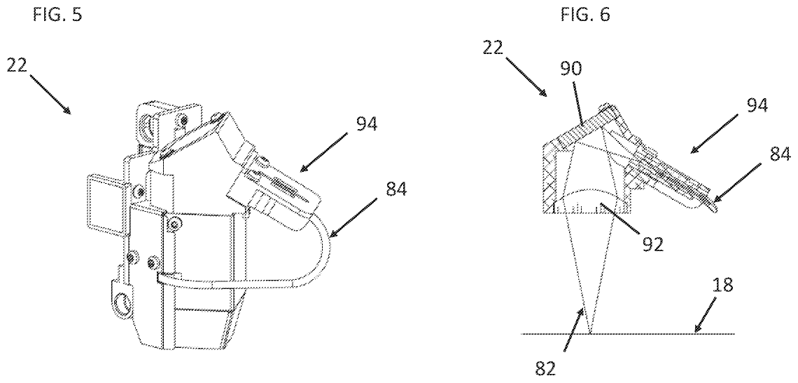

Referring to FIGS. 3-8, the printing assembly 20 is a laser printing assembly. The assembly 20 comprises a laser print carriage 22 and a plurality of laser diodes 80 for laser printing on media 18 such as smokeless media. As illustrated in FIG. 3-6, the print carriage 22 supports the optics that direct a plurality of laser beams 82 to the media 18 for laser printing. The plurality of laser diodes 80 may be spaced apart from the print carriage 22 and/or supported by internal support structures in the system 10, for example the diodes 80 may be stationary inside the printer or carried by the printing assembly 20. The diodes 80 are optically connected to the print carriage 22 by optical fibers 84. The optical fibers 84 deliver the laser beams 82 to a fiber optic positioning block 94. This block 94 is a termination block where the fiber optic cables connect thereto and the laser beams 82 are then emitted from the block 94 and directed into the print carriage 22. The termination block 94 is coupled to the print carriage 22. A cooling fan may also be provided on the carriage 22 to remove heat build-up from laser printing.

The fiber optic cables 84 provide light from the diodes 80 to the termination block, which provides the light in the form of diverging laser beams 82 to the print carriage 22. The light from these beams is diverging as it enters the print carriage 22 as illustrated in FIG. 6, and the laser beams 82 are directed to a mirror 90, where the laser beams are reflected downwardly towards a focusing lens 92. The mirror 90 is positioned at an angle within the print carriage 22 to receive the laser beams 82 and direct the laser beams through the print carriage 22 in a direction away from the direction which the laser beams entered the print carriage 22. The lens 92 receives the diverging beams directly from the mirror 90 and focuses the beams 82.

The focal points of the beams 82 are then directed from the lens 92 to the media 18. The single mirror 90 and single lens 92 system for directing laser beams 82 to the media allows for a more compact print assembly 20 and the arrangements described herein eliminate the need for a collimating lens.

The system 10 may be provided with a plurality of laser diodes 80 and thus a plurality of laser beams 82 are generated and used for printing. The system 10 may include, but is not limited to two, four, and eight laser diode 80 systems. The mirror 90 is provided to achieve a smaller vertical footprint for the print carriage itself and in combination with elimination of a collimating lens, the size of the assembly is further reduced.

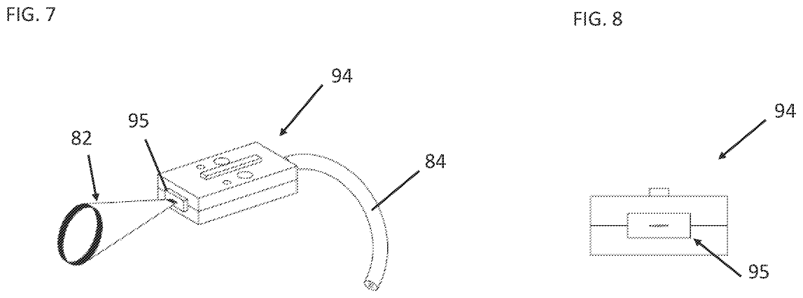

Each laser diode 80 may be located remotely or otherwise spaced apart from the movable print carriage 22. For example, the diodes 80 may be supported within the print system 10 spaced from the moveable print carriage 22. The fiber optic cables 84 for each laser diode 80 are routed up to the print carriage 22 in a flexible, protected bundle. This allows the print carriage 22 to move across the print system 10 for printing without the diodes 80 moving in tandem. The positioning block 94 is also referred to as a termination block 94. As described previously, the positioning block illustrated in further detail in FIGS. 7 and 8, receives the fiber optic bundle and couples the cables 84 to the print carriage 22, while the laser beams 82 are emitted from terminal ends of the fiber optic cables 84 at an optical outlet 95 of the block 94. The outlet 95 is positioned such that the beams 82 are then emitted directly into the print carriage 22. The laser beams 82 expand or diverge (approximately 12.6°) as the beams 82 leave the fiber ends at the outlet 95 of the block 94 and thus the positioning or termination block 94 is aimed at the mirror 90 to reflect the still diverging beams downwardly through the lens 92, which focuses the beams 82 and directs the focal points to the media 18 as described above.

In standard positioning, the laser optic fibers cannot be positioned close enough in the termination block 94 to obtain a high-resolution image such as 300 DPI when printing. A primary reason for this is that each laser beam in each laser optic fiber is contained by a wall. In an illustrative example, the laser optic fiber is approximately 250 microns in diameter containing a beam within an inner wall of approximately 100 microns in diameter. Thus, two laser beams are then separated by approximately 150 microns of fiber optic wall. The dots being formed on the media would then be separated, inhibiting a high-resolution image. The spacing of the print carriage from the media is limited by the compact nature of the printer of this disclosure. It was found that if the print assembly, that is the print carriage 22 and the termination block 94 coupled thereto, were tilted from an orthogonal axis with respect to the media, the dot formation on the media could be of a high resolution, for example 300 DPI. Tilting the print assembly reduces the effect of the optic fiber walls resulting in closer dot formation.

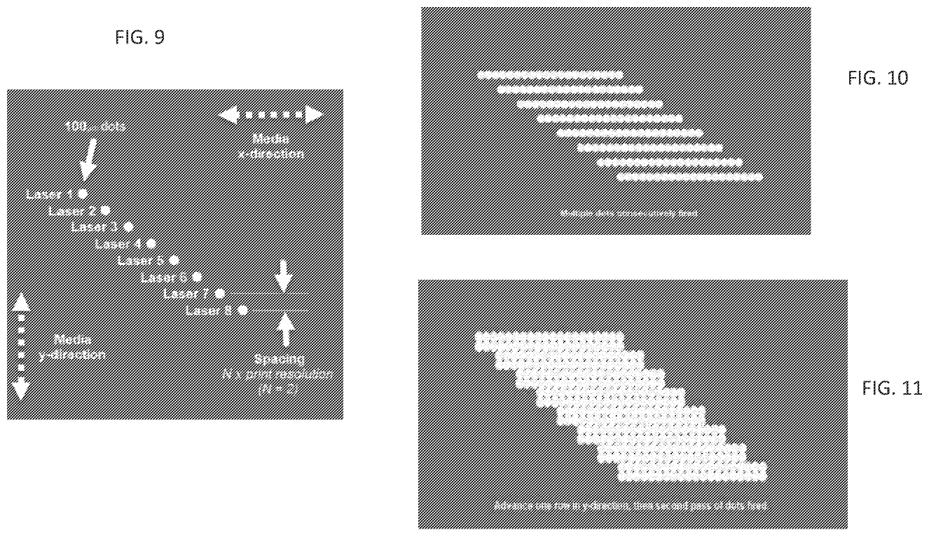

FIGS. 9 through 11 illustrate an exemplary printing and resolution scheme using the laser arrangement of this disclosure. For this example, each individual laser produces a distinct dot in a row of dots while moving in the x-direction, left to right, producing eight (8) rows of dots when eight (8) laser fibers are used, as illustrated in FIG. 10. Then the media moving in the y-direction indexes for the next row of dots to be produced and the laser beams are then moved in an opposite x-direction, right to left and between the previously formed rows of dots. This second row of dots “fills” in between the previously formed rows of dots to complete a section of “print”.

In certain embodiments, a size of the laser beams 82 at the media 18 interface (e.g., focal point) may be less than approximately 100 μm, approximately 100 μm, approximately 150 μm, approximately 200 μm, or more. In one or more embodiments, the lasers have a wavelength in the range of approximately 976 nm to approximately 980 nm.

The cutting assembly 30 correspondingly comprises one or more cutting knives 32 for cutting the perimeters around printed images. An electromagnet 33 may also be positioned on the cutting assembly 30 housing. The electromagnet 33 could be used to selectively attach the printing assembly 20 to the cutting assembly 30. In the embodiment illustrated, the printing assembly 20 is driven by a drive belt 51 attached to the motor 13. In the embodiment illustrated the cutting assembly 30 is a plotter cutter.

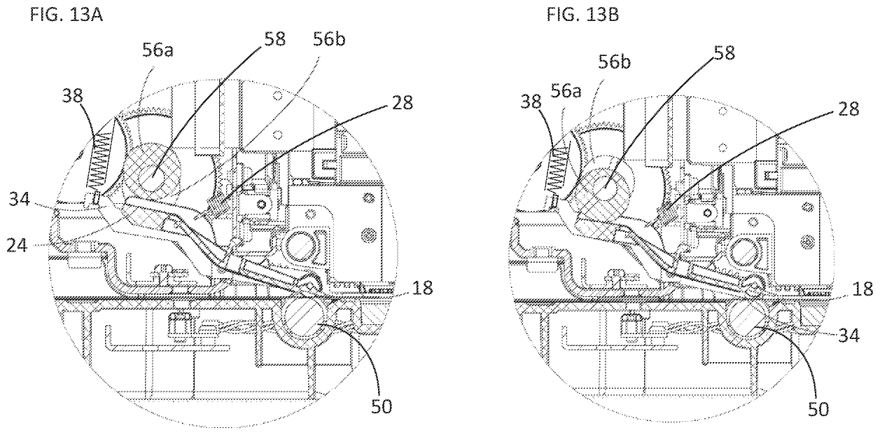

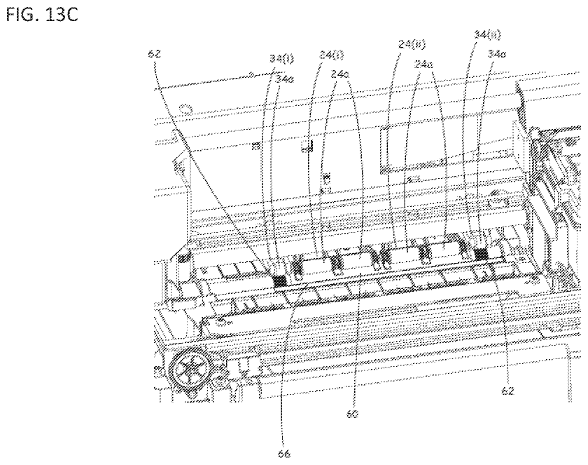

Referring to FIGS. 13A to 13C, the system 10 may also comprise a first pair of pinch levers 24 also referred to as printing pinch levers or inner pinch levers. A second pair of pinch levers 34 also referred to as cutting pinch levers or outer pinch levers. As used in connection with the pairs of pinch levers 24, 34, the terms are inner and outer are relative to one another. The inner pinch levers 24 are spaced apart from one another but are positioned inside a space separating the outside pinch levers 34. The pairs of pinch levers 24, 34 are positioned near the processing window to retain the media 18 as is it being printed or cut. Each pair of pinch levers 24, 34 selectively contacts the media 18 to pinch or guide the media during printing or cutting. Each pinch lever has at least one idler roller to create a nip point with the media drive roller 50. In the embodiment illustrated the first pair of pinch levers have two idler rollers 24a per lever and the second pair of pinch levers have one idler roller 34a per lever.

The inner pinch levers 24 are in a “down” position such that the inner pinch levers 24 are in contact with the media 18 when the printing assembly 20 is operating to print one or more images on the media 18. The outer pinch levers 34 are thus in an “up” position such that the outer pinch levers 34 are not in contact with the media 18.

The outer pinch levers 34 are in a “down” position such that the outer pinch levers 34 are in contact with the media 18 when the cutting assembly 30 is operating to cut one or more printed images from the media 18. The inner pinch levers 24 are thus in an “up” position such that the inner pinch levers 24 are not in contact with the media 18.

A motor is operably connected to one or more pinch lever cams 56 and a shaft 58 such that the cam shaft 58 rotates to raise and/or lower the respective pair of pinch levers 24, 34. The pinch levers 24, 34 are spring operated with respective pinch lever springs 28, 38 for changing position of the respective pair of levers 24, 34. The inner pinch lever spring 28 provides a first pinch force to the inner pinch levers 24 when in the down position and contacting the media 18. The outer pinch lever spring 38 provides a second pinch force to the outer pinch levers 34. The force may be substantially the same or different between the pairs of pinch levers 24, 34. In the embodiment illustrated, the outer pinch levers 34 have a greater pinch force than the inner pinch levers 24.

Prior art label printers are set up with media pinch levers spaced across an entire media width of the device and provide enough force to allow the media to move forward without noticeable slip during the printing operation, but also allow slight slips to correct for skew in the media path if the media begins to track off course and bumps into fixed media edge guides within the printer. This skew correction mostly occurs during media feed operations so as not to affect print quality.

The media pinch levers 24, 34 and cams 56 are used to lift selected levers 24 or 34 during certain operations such as printing or plotting. The cams comprise inner cams 56a and outer cams 56b where the inner pinch levers 24 have cams 56a that are not engaged with the interior levers 24 when the levers 24 are in the down position and in contact with the media. The outside cams 56b then engage the outer levers 34 to lift up the pinch levers 34 off of the media as shown in FIG. 13A. In FIG. 13B, the interior cams 56a lift the inner levers 24 up so the levers are not touching the media while the outside cams 56b are not engaged with the outer levers 34 to allow the levers 34 to move down and pinch the media 18.

The pinch levers 24 and 34 are multi-force levers such that the inner pinch levers 24 have a different pinch force than the outer pinch levers 34. The two inside levers 24 are in a down position during printing to pinch the media 18 and once printing is complete, a cam shaft 58 rotates 180° causing the two inside levers 24 to lift up and concurrently allow the pair of outer pinch levers 34 to move to the down position. The two outside levers 34 have a much higher pinch force than the inside levers 24 as the increased pinch force is beneficial for cutting the images from the media and holding the media in place during cutting.

A sensor may be provided for rotation of the cam shaft 58 for switching operational positions of the levers 24, 34.

The cam shaft 58 extends across the width of the housing 12 across the width of the media 18 and processing window. A frame 15 supports each of the levers 24(i), 24(ii) and 34(i), 34(ii) thereon and are raised or lowered using the cam shaft 58. The levers 24, 34 are positioned with respect to the processing window to hold the media 18 when printing or cutting respectively. The arrangement of the levers 24, 34 in the system 10 addresses issues with media feeding and tracking media through the printer when using the cutting assembly 30. Prior art systems require wider media, s-wraps around feed rollers, have active media tracking controls, or have separate drive systems for printing and cutting to keep the media moving through the system and tracking nicely in a substantially flat and sufficiently taut state. However, system 10 disclosed herein allows for a reduction in cost and size of the apparatus, while eliminating the need for wider media, s-wraps, active media tracking controls, and separate drive systems for printing and cutting by way of the pinch levers described herein.

When plotter cutting the label shapes out of the continuous media 18, extra drag from the knife blade will make the media tend to skew to one side or the other, depending upon where the knife is cutting and the direction it is moving. To overcome this skew, more force is provided to the outside pinch levers. If the extra force is used on the inside levers, or the printing pinch levers, during the printing process the media will be unable to slip and self-correct when bumping into the fixed media guides and will instead continue to drive into the fixed edge guides until it rolls over on itself enough to cause a media jam. To address these opposing needs, the device 10 allows for lighter (standard) force printer pinch levers to be used when printing and heavier force pinch levers to be used on the outside when cutting. This allows the media to correct its path when in the print mode, and the levers to grip the media tightly enough to not slip while in the plotting mode. The overall length of the plotting cut along the length of the media web will be limited by how accurately the media is aligned during the print mode. In this device 10, the plot length can be up to about 30″ with good operation, which satisfies the needs of the vast majority of the label market.

For printing and cutting, the media 18 is fed from the roll web guide 16 into the housing 12 and may pass through an adjustable media guide as the media enters into the processing window. The media 18 is also moved through the device by way of the drive roller 50 where the media passes over the drive roller 50.

The drive roller 50, in connection with a paper feed motor 72, controls the advancing of the media through the printer. The media may move through the device in reciprocal directions (e.g., forward and backward along the web direction) to assist in printing and cutting of perimeters around the printed image(s) as the printing assembly 20 and the plotter cutter assembly 30 move in reciprocal directions across the media 18 width.

The sheet cutter 40 is provided for separating sheets from or otherwise trimming the printed and cut media 18 exiting the housing 12. This is an optional cutter that may also be used to separate scrap material or otherwise cut the media 18 from the supply roll into sheets having shorter lengths so as to enable easier stacking, removal or other uses of the media. The sheets cut by the sheet cutter 40 may have one or more separated or cut target image therein which can be manually removed from the cut sheet or media and the scrap media reused, recycled, or discarded.

A main control board 70 is provided for electrical connections to enable printing and cutting operations and the control board may be a printed circuit board 70.

In order to achieve greater levels of accurate tracking during the plotting (cutting) process, embodiments of the system 10 may further comprise a finely knurled segment 62 which may be added to the print roller 50 in the areas aligned underneath the plotting levers. The area between the knurled segments thus remains a grit surface. The knurled segments provide a greater co-efficient of friction than the grit surface to allow for increased gripping by the outer levers during cutting.

For example, the knurled segments 62 are positioned on opposing ends of the print roller 50 and are each aligned to one of the outer pinch levers 34 while the inner pinch levers 24 are positioned on the grit portion 60 of the print roller 50. A plotter knife holder may also be positioned adjacent the print roller 50 and a plotter cutter wear strip 66 may be positioned forward of the print roller 50.

As discussed previously above, the system 10 is configured for use with “smokeless” media, which allows the system 10 to eliminate the need for an air filtration or smoke filtration system as generally required in laser label printers. Even if smokeless media is used in a standard laser label printer such printers still require cutting of the perimeter of the label with the laser and as such still require a filtration system. The system 10 according to one or more embodiments herein eliminates the need for a filtration system and thus the unit itself is far more compact and the cost is reduced.

Although the present disclosure has been described with reference to preferred embodiments, workers skilled in the art will recognize that changes may be made in form and detail without departing from the spirit and scope of the disclosure.

1. An assembly for printing and cutting print media comprising:
a housing and a print carriage within the housing; and
a laser printing assembly and a digital die cutting assembly, both being disposed on the carriage.

2. The assembly of claim 1 wherein the laser printing assembly is configured to print content onto smokeless media and wherein the assembly does not require a filtration system.

3. The assembly of claim 2 wherein the laser printing assembly comprises a plurality of laser diodes.

4. The assembly of claim 3 and wherein the printing assembly further comprises a positioning block for aligning optical fibers through which laser beams are transmitted, a mirror and a focusing lens for directing the laser beams to the print media.

5. The assembly of claim 3 wherein laser printing assembly is tilted with respect to the print carriage to vary a spacing between pixels being formed on print media so as to control print resolution.

6. The assembly of claim 1 wherein the laser printing assembly comprises a single mirror and a single focusing lens for directing laser beams to the print media.

7. The assembly of claim 6 wherein the laser printing assembly does not require a collimating lens.

8. The assembly of claim 1 wherein the print media is provided as a continuous web of print media fed through the housing for printing and cutting and wherein the assembly further comprises a sheet cutter for separating sheets or a small roll from a web of the print media.

9. A printer for laser printing labels, the printer comprising:
a printing assembly comprising a focusing lens, a mirror, and a laser beam transmission block containing multiple optic fibers disposed within the block for transmitting multiple laser beams therefrom;
a housing with a feed system for presenting media to be laser printed; and
wherein the printing assembly is positioned such that the multiple laser beams are tilted from a position orthogonal to the media sufficiently to adjust the formation of pixels to a selected dots per inch resolution.

10. The printer of claim 9 wherein the transmission block aligns laser beams from two, four, or eight laser diodes.

11. The printer of claim 9 wherein the printing assembly is sufficiently tilted to form images on the media at a resolution of at least 300 DPI.

12. A laser printer configured to print on smokeless media, the laser printer comprising:
a housing and a carriage within the housing;
a laser block retaining multiple laser fibers positioned in a manner that directs laser beams from the laser fibers to the smokeless media without the use of a collimating lens while producing images having at least approximately 300 dpi resolution on the smokeless print media.
